(19) United States
(12) Patent Application Publication
(10) Pub. No.: US 2020/0213716 A1
(43) Pub. Date: Jul. 2, 2020

(54) SOUND DEVICE

(71) Applicant: AAC Technologies Pte. Ltd., Singapore city (SG)

(72) Inventor: Yuguo Zhang, Shenzhen (CN)

(21) Appl. No.: 16/705,175

(22) Filed: Dec. 5, 2019

(30) Foreign Application Priority Data
Dec. 27, 2018 (CN) 201822228072.8

(51) Int. Cl. H04R 1/28; H04R 1/02

(52) U.S. Cl. CPC H04R 1/2811; H04R 1/025

(57) ABSTRACT

The present invention relates to electroacoustic technologies and provides a sound device. The sound device includes a top cover, a bottom cover, a sound unit and a housing. The top cover includes a bottom surface and a side surface matched with an inner wall of the housing, and the bottom surface and the side surface are connected in smooth arc transition. The sound unit and the housing define a front cavity, and a housing hole in the housing is communicated with the front cavity to form a sound channel. A flexible sealing material attached to the bottom surface and the side surface is arranged around a periphery of the front cavity, and the inner wall of the housing, the bottom surface and the side surface clamp the flexible sealing material together.

### TECHNICAL FIELD

The present disclosure relates to electroacoustic technologies, and more particularly, to a sound device.

### BACKGROUND

With a rapid development of science and technology, people have higher requirements on functionality of products in a process of rapid development of an audio device, and for a sound device, more and more people put forward higher requirements on audio performance.

In related technologies, a front cavity and a housing are in sealing fit around a sound hole, and a hole wall obstructs a forward circulation of airflow to a certain extent, so that the airflow needs to climb to a housing hole through the sound hole, causing a sound channel to be tortuous, which is not conducive to airflow and audio performance of the whole sound device.

### BRIEF DESCRIPTION OF THE DRAWINGS

FIG. 1 is a schematic diagram illustrating an overall structure of a sound device in an embodiment of the present disclosure;

FIG. 2 is a schematic diagram illustrating a main view structure in FIG. 1;

FIG. 3 is an A-A sectional view in FIG. 2;

FIG. 4 is a schematic diagram illustrating a top view structure in FIG. 1;

FIG. 5 is a B-B sectional view in FIG. 4; and

FIG. 6 is a partial structure diagram in FIG. 1.

### DETAILED DESCRIPTION

To make objectives, technical solutions, and advantages of the present invention clearer, the present invention is further described in detail hereinafter with reference to accompanying drawings and embodiments. It should be understood that the specific embodiments described here are only for explaining the present invention, and are not used for limiting the present invention.

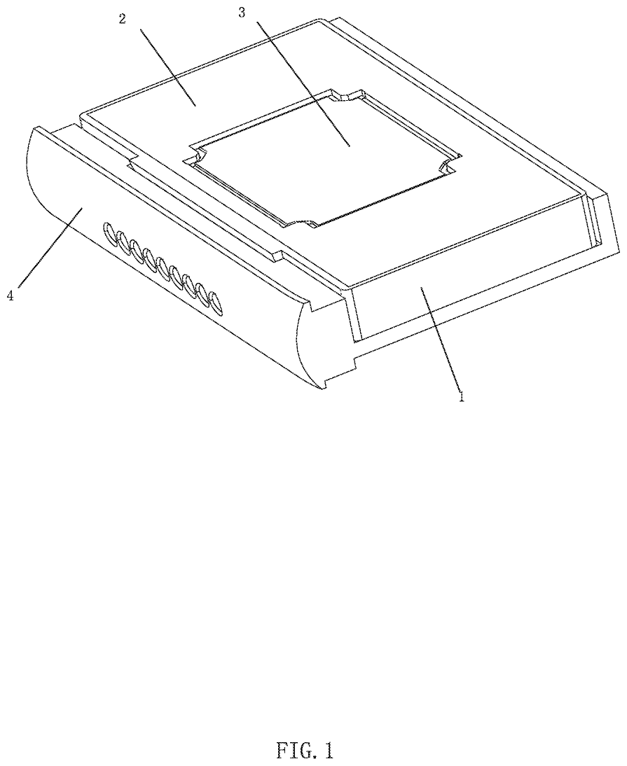

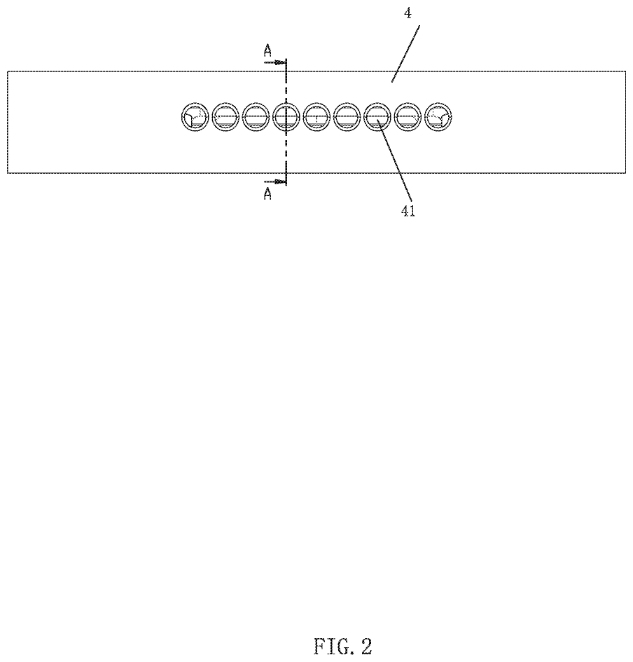

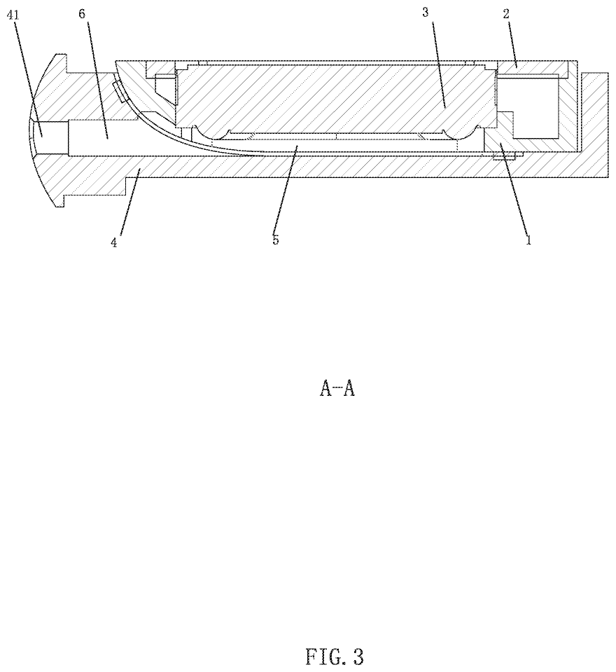

Referring to FIG. 1 to FIG. 4, a sound device is provided in the embodiment of the present disclosure. The sound device includes a top cover 1, a bottom cover 2 defining an accommodating space with the top cover 1, a sound unit 3 accommodated in the accommodating space, and a housing 4 accommodating the top cover 1. The top cover 1 includes a bottom surface 11 and a side surface 12 matched with an inner wall of the housing 4, and the bottom surface 11 and the side surface 12 are connected in smooth arc transition. The sound unit 3 and the housing 4 define a front cavity 5, a housing hole 41 communicated with the outside is arranged in the inner wall of the housing 4 matched with the side surface 12, and the housing hole 41 is communicated with the front cavity 5 to form a sound channel 6. A flexible sealing material 7 attached to the bottom surface 11 and the side surface 12 is arranged around a periphery of the front cavity 5, and the inner wall of the housing 4, the bottom surface 11 and the side surface 12 clamp the flexible sealing material 7 together. The side surface 12 of the top cover 1 and the bottom surface 11 of the top cover 1 are connected in smooth transition, the bottom surface 11 and the side surface 12 are provided with the flexible sealing material 7, and the flexible sealing material 7 surrounds the periphery of the front cavity 5. In this way, a side portion of the front cavity 5 is opposite to the housing hole 41, so that airflow in the front cavity 5 can be directly communicated with the housing hole 41 without climbing or bending, and can smoothly flow into the housing hole 41, which is beneficial for improving the airflow of the whole device and improving the medium-high frequency SPL performance.

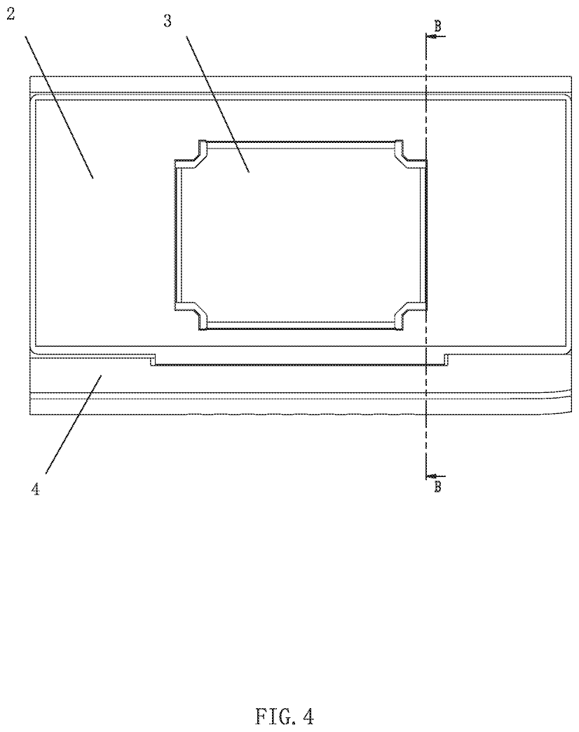

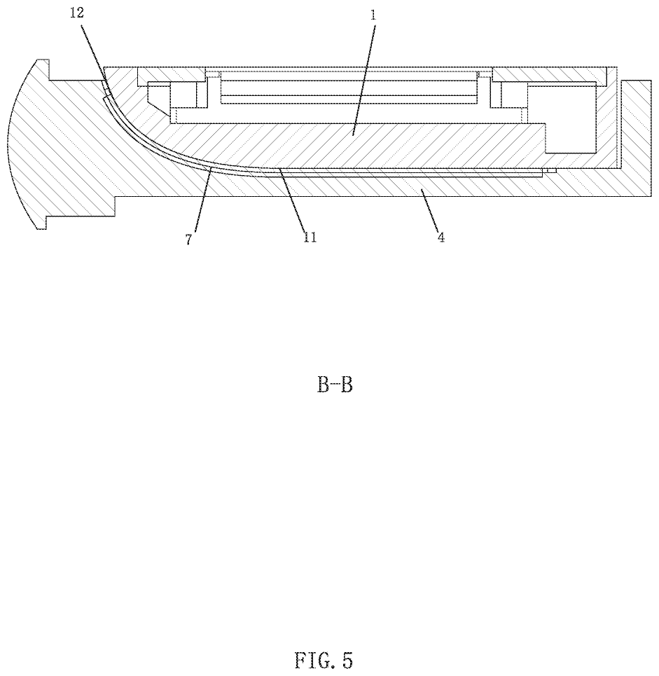

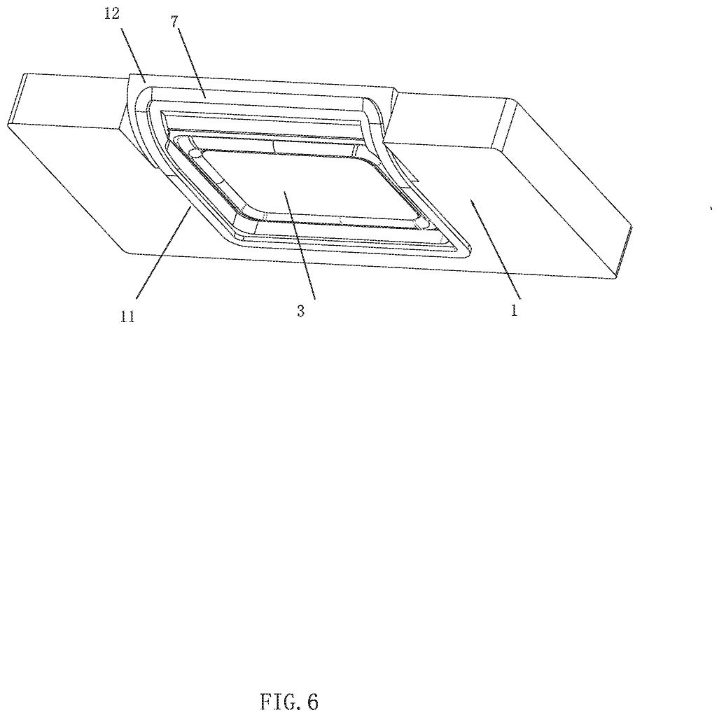

In the embodiment, as shown in FIG. 4 to FIG. 6, the flexible sealing material 7 is as a whole. The flexible sealing material 7 extends from the side surface 12 to the bottom surface 11, and surrounds the periphery of the front cavity 5, thus sealing an edge of the entire front cavity 5. Since the flexible sealing material 7 extends to the bottom surface 11 and plays the same sealing role as a steel sheet or a plastic material, the steel sheet or the plastic material is no longer arranged between the bottom cover 2 and a bottom plate of the housing 4. At the moment, height space occupies by the unit is composed of a distance from the bottom cover 2 in a speaker to the sound unit 3 and a height of the sound unit 3 and an amplitude space of the sound unit 3. Compared with existing technologies, a vertical height of the steel sheet or the plastic material is reduced, thus reducing an overall height and saving a space of the whole device. Optionally, the flexible sealing material 7 is in a rectangular shape. In other embodiments, the flexible sealing material 7 may also be in a circular shape or the like as long as the flexible sealing material 7 can surround the periphery of the entire front cavity 5. Optionally, the flexible sealing material 7 is injection-molded soft glue, adhesive elastic foam, adhesive silica gel or rubber. The injection-molded soft glue may be an elastic material such as silica gel, TPU (thermoplastic polyurethanes) and the like.

In other embodiments, the side surface 12 of the top cover 1 may also be in a plane shape obliquely arranged, and a lower end thereof is inclined to a side away from the inner wall of the housing 4 and is connected with the bottom surface 11. The embodiment can also ensure smoothness of airflow flowing from the front cavity 5 into the housing hole in the housing 4. Except for the structure above, other structures of the embodiment are all the same as those of the embodiment above, and will not be repeated here.

The description above is merely embodiments of the present disclosure, and it should be pointed out that, those of ordinary skills in the art can make improvements without departing from the inventive concept of the present disclosure, but these all belong to the scope of protection of the present disclosure.

What is claimed is:

1. A sound device, comprising a top cover, a bottom cover defines an accommodating space with the top cover, a sound unit accommodated in the accommodating space, and a housing accommodating the top cover, wherein the top cover comprises a bottom surface and a side surface that are matched with an inner wall of the housing, and the bottom surface and the side surface are connected in smooth arc transition; wherein the sound unit and the housing define a front cavity, a housing hole communicated with the outside is arranged in the inner wall of the housing matched with the side surface, and the housing hole is communicated with the front cavity to form a sound channel; wherein a flexible sealing material attached to the bottom surface and the side surface is arranged around a periphery of the front cavity, and the inner wall of the housing, the bottom surface and the side surface clamp the flexible sealing material together.

2. The sound device according to claim 1, wherein the flexible sealing material is an integral surrounding structure.

3. The sound device according to claim 2, wherein the flexible sealing material is injection-molded soft glue, adhesive elastic foam or adhesive silica gel

4. The sound device according to claim 2, wherein the flexible sealing material is in a rectangular shape.

5. The sound device according to claim 4, wherein the flexible sealing material is injection-molded soft glue, adhesive elastic foam or adhesive silica gel.
